(19) United States
(12) Patent Application Publication
(10) Pub. No.: US 2026/0222395 A1
(43) Pub. Date: Jul. 30, 2026

(54) PRESCRIPTIVE ADVERTISING OF VALID SECURITY COMBINATIONS WITHIN A SERVICE SET IDENTIFIER (SSID)

(71) Applicant: Cisco Technology, Inc., San Jose, CA (US)

(72) Inventors: Anuj Dharap, Copley, OH (US); Stephen M. Orr, Wallkill, NY (US)

(73) Assignee: Cisco Technology, Inc., San Jose, CA (US)

(21) Appl. No.: 19/573,663

(22) Filed: Mar. 20, 2026

Related U.S. Application Data
(63) Continuation of application No. 19/397,327, filed on Nov. 21, 2025.
(60) Provisional application No. 63/725,257, filed on Nov. 26, 2024.

(51) Int. Cl. H04L 9/40; H04L 9/06

(52) U.S. Cl. CPC H04L 63/065; H04L 9/0618

(57) ABSTRACT

Prescriptive advertising of valid security combinations within a Service Set Identifier (SSID) may be provided. A computing device may determine supported security combinations that are supported by the computing device. Next, the computing device may indicate the supported security combinations in an information element. Then the computing device may advertise the information element.

### RELATED APPLICATIONS

Proposed application is a continuation of U.S. patent application Ser. No. 19/397,327 filed November 21, 2025, which claims the benefit of U.S. Provisional Application No. 63/725,257, filed November 26, 2024.

### TECHNICAL FIELD

The present disclosure relates generally to providing prescriptive advertising of valid security combinations within a Service Set Identifier (SSID).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing prescriptive advertising of valid security combinations within a Service Set Identifier (SSID);

FIG. 2 is a flow chart of a method for providing prescriptive advertising of valid security combinations within an SSID; and

FIG. 3 illustrates a supported security combinations information element;

FIG. 4 illustrates a format for supported security combination bit field content;

FIG. 5 illustrates an example format for supported security combination bit field content; and

FIG. 6 is a block diagram of a computing device.

### DETAILED DESCRIPTION

### OVERVIEW

Prescriptive advertising of valid security combinations within a Service Set Identifier (SSID) may be provided. A computing device may determine supported security combinations that are supported by the computing device. Next, the computing device may indicate the supported security combinations in an information element. Then the computing device may advertise the information element.

Both the foregoing overview and the following example embodiments are examples and explanatory only and should not be considered to restrict the disclosure’s scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Due to the expansion and proliferation of new cipher suites, Authentication and Key Management (AKM) suites, and Diffie–Hellman (DH) groups alongside pre-existing security implementations, the number of possible and technically valid security combinations in a WLAN has exponentially increased. Additionally, a given Basic Service Set (BSS) may advertise a variety of these security combinations at any given point of time to extend coverage for a wider range of client devices (i.e., Stations (STAs)). This may be seen in Wi-Fi 7 for example, where to extend compatibility alongside with mandatory support requirements for certain cipher suites and AKMs (e.g., AKM 24 and Galois/Counter Mode Protocol (GCMP) 256), a multitude of AKMs and Cipher Suites are advertised within the same WLAN spanning support for Wi-Fi Protected Access (WPA2) and WPA3, as well as Electrical and Electronics Engineers (IEEE) 802.11w combinations.

All of these changes and additions may bring with them a host of added complexities for association handling on the AP end, as well as an increased chance that client devices choose niche, or invalid configuration(s) among those advertised, causing association delays and failures. Furthermore, with conventional systems in a singular Service Set Identifier (SSID), it may not be possible to advertise support for IEEE 802.1x and personal security alongside each other. This may require separate WLANs to be spun up, consuming effective Radio Frequency (RF) airtime available for actual data exchange(s) and management overheads.

Accordingly, embodiments of the disclosure may provide a prescriptive information element aimed at advertising specific valid security combinations within an SSID. This may allow for a more clarified approach to client authentication in an SSID working in conjunction with the Robust Security Network Element (RSNE) (e.g., which advertises support for all AKMs and Cipher Suites supported). Embodiments of the disclosure may allow an SSID to inform client devices of specific AKM and Cipher Suite combinations supported, reducing client connectivity issues that exist in conventional systems due to clients picking unsupported combinations of AKMs, Cipher Suites, and more. Furthermore, embodiment so the disclosure may also be utilized to eventually supersede the complicated RSNE element in its entirety, allowing a single information element to provide a complete, cohesive list of supported security combinations within an SSID. Embodiments may even allow a single SSID the freedom to blend different authentication processes for example.

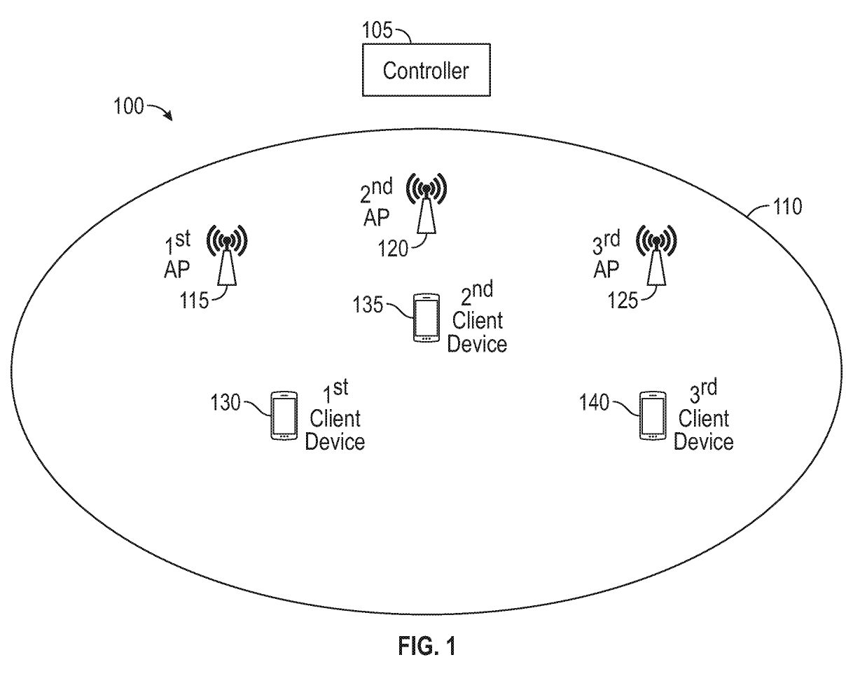

FIG. 1 shows an operating environment 100 for providing prescriptive advertising of valid security combinations within a Service Set Identifier (SSID). As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

The plurality of APs may provide wireless network access to a plurality of client devices (i.e., Station (STAs)) as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard.

The plurality of APs and the plurality of client devices may use Multi Link Operation (MLO) where they simultaneously transmit and receive across different bands (or links) and channels by establishing two or more links to two or more AP radios. These bands may comprise, but are not limited to the 2.4 GHz band, the 5 GHz band, the 6 GHz band, and the 60 GHz band. The two or more links on any given one of the plurality of client devices may be made with any one AP or with any combination of the APs.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide prescriptive advertising of valid security combinations within an SSID.

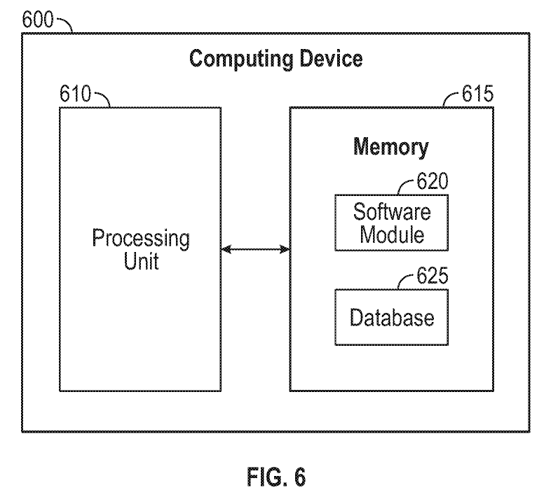

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 6, the elements of operating environment 100 may be practiced in a computing device 600.

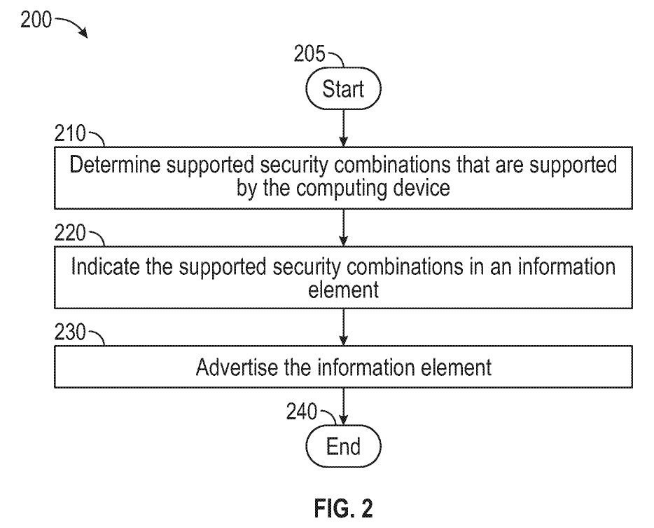

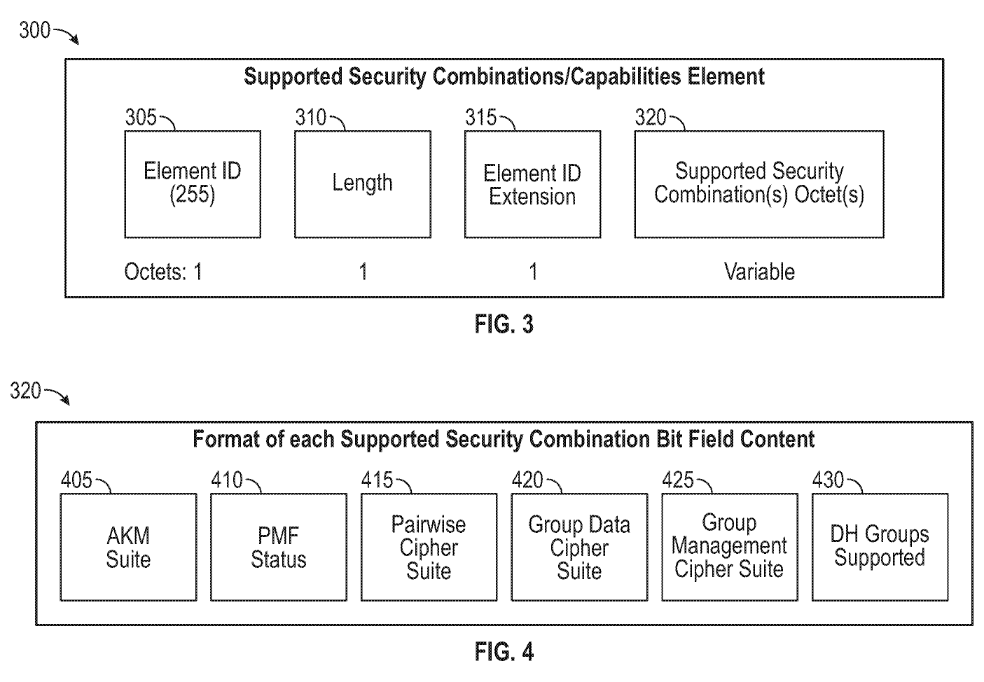

FIG. 2 is a flow chart setting forth the general stages involved in a method 200 consistent with embodiments of the disclosure for providing prescriptive advertising of valid security combinations within a Service Set Identifier (SSID). Method 200 may be implemented using a computing device 600 as described in more detail below with respect to FIG. 6. Computing device 600 may be embodied, for example, by any of the plurality of APs, the plurality of client devices, or controller 105. Ways to implement the stages of method 200 will be described in greater detail below.

Method 200 may begin at starting block 205 and proceed to stage 210 where computing device 600 may determine supported security combinations that are supported by computing device 600. For example, the determined supported security combinations may comprise one or more of an AKM suite, a Protected Management Frames (PMF), a Pairwise Cipher Suite, a Group Data Cipher, a Group Management Cipher Suite, and a Diffie-Hellman (DH) group. The aforementioned are examples and embodiments of the disclosure are not limited to them and may include other determined supported security combinations.

Supported security combinations information element 300 may comprise element ID field 305, length field 310, element ID extension field 315, and supported security combinations field 320. The length of supported security combinations field 320 may be variable, with the supported security combination(s) octet count equaling “Length-1” for example. If fewer bits are received in supported security combinations field 320 than defined, the rest of the field bits may be assumed to be zero, indicating that the SSID lacks support for any other authentication processes.

Each supported security combination(s) octet may act as a bitfield indicating capabilities support (or lack thereof) of a set of security combination(s) being advertised by the AP or client device transmitting (i.e., advertising) supported security combinations information element 300. Such a combination may help an SSID delineate a prescriptive list of AKM + Cipher Combinations that may be supported, as well as potentially allow for the advertisement of different authentication processes over a single WLAN (e.g., IEEE 802.1x alongside Simultaneous Authentication of Equals (SAE) or Opportunistic Wireless Encryption (OWE)) thus decreasing airtime/management overheads as well.

Bit 0 within supported security combinations field 320 may be used to indicate support (or lack thereof) of Open Security within the SSID. Each following supported security combinations field 320 content may be defined as a combination of elements defined as follows and illustrated by FIG. 4. Supported security combinations field 320 may comprise a first element 405 comprising an AKM suite selector indicator. Supported security combinations field 320 may comprise a second element 410 comprising a PMF status indicator. Supported security combinations field 320 may comprise a third element 415 comprising a Pairwise Cipher Suite indicator. Supported security combinations field 320 may comprise a fourth element 420 comprising a Group Data Cipher Suite indicator. Supported security combinations field 320 may comprise a fifth element 425 comprising a Group Management Cipher Suite indicator. Supported security combinations field 320 may comprise a sixth element 430 comprising a Diffie-Hellman (DH) group supported indicator. Consistent with embodiments of the disclosure, supported security combinations field 320 may comprise any number of elements and is not limited to the six shown in FIG. 4 and may be included in any order. A final list of supported security combination fields content and list may be defined by a standards body to ensure interoperability for example.

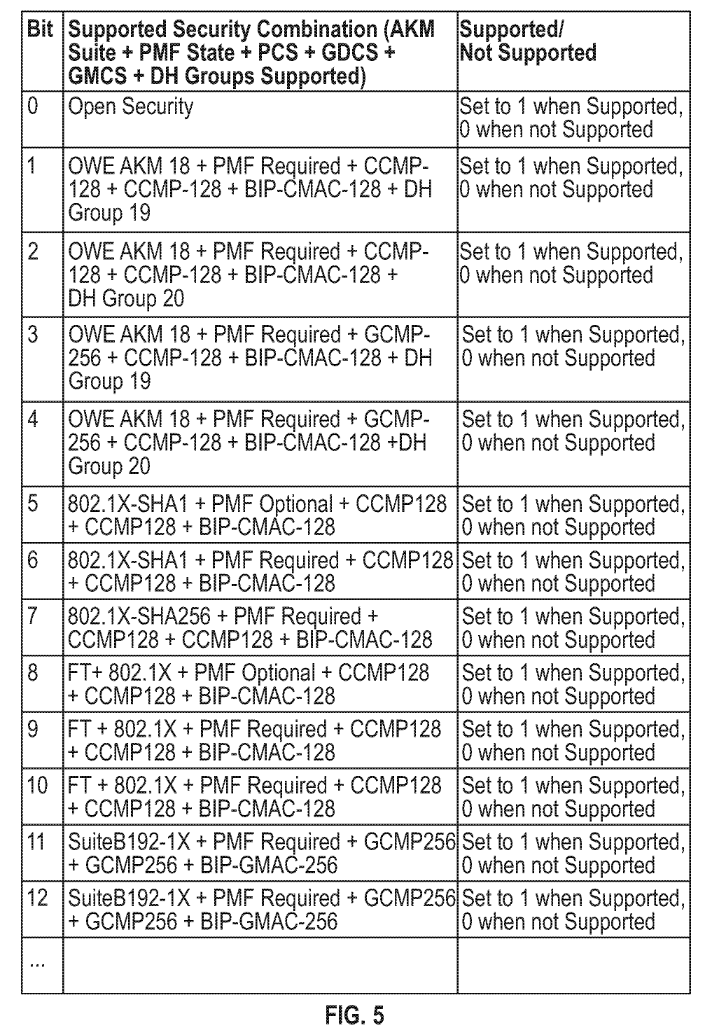

An example of supported security combinations field 320, covering Open, OWE, and some combinations of Enterprise Security, may be defined in the manner illustrated in FIG. 5. Such supported security combinations field 320 may allow a single SSID to advertise support for a multitude of authentication processes (e.g., Open, OWE, IEEE 802.1x, Pre-Shared Key (PSK)/SAE Based, etc.) and AKM + Cipher combinations in a simplified, clear manner.

In the near term, this may be included alongside the RSNE, helping narrow down and define the exact combinations of AKM + Cipher Suites Supported from within all laid out in the RSNE. This may help narrow down and simplify authentication management support overheads, while allowing advertisement of a wider total range of supported security combinations (e.g., AKMs and Cipher Suites) in a coherent and clear manner.

In the long term, such a process may be used to supersede the complicated and burdensome RSNE element in its entirety, allowing a single information element to provide a complete, cohesive list of supported security combinations within an SSID even allowing a single SSID the freedom to blend different authentication processes (e.g., Open, OWE, IEEE 802.1x, PSK/SAE based, etc.). This approach may help in reducing network management overheads while also allowing for the simultaneous use of a wide range of network authentication processes within a single broadcasted SSID.

Once computing device 600 indicates the supported security combinations in the information element in stage 220, method 200 may continue to stage 230 where computing device 600 may advertise the information element. For example, the information element may be advertised by an AP or client device in beacons or probes. Once computing device 600 advertises the information element in stage 230, method 200 may then end at stage 240.

FIG. 6 shows computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing prescriptive advertising of valid security combinations within an SSID as described above with respect to FIG. 2. Computing device 600, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising
implementing, by an access point, a Basic Service Set (BSS) for one or more wireless stations, the BSS identified by a Service Set Identifier (SSID);
accessing, by the access point, information indicating one or more security combinations supported by the BSS,
each of the one or more security combinations comprising an Authentication and Key (AKM) suite and a cipher suite;
encoding one or more management frames to include a security information element, the security information element including information indicating a set of the one or more security combinations supported by the BSS;
transmitting, by the access point, the one or more encoded management frames in the BSS.

2. The method of claim 1 wherein the information indicating the set of the one or more security combinations supported by the BSS in the security information element comprises
one or more security profile values,
each security profile value uniquely corresponding to one of the one or more security combinations supported by the BSS.

3. The method of claim 1 wherein the information indicating the set of the one or more security combinations supported by the BSS in the security information element comprises
a bitmap comprising a plurality of bits, each bit corresponding to a unique one of the one or more security profile values,
the value of each bit set to indicate whether the corresponding security profile value is supported by the BSS.

4. The method of claim 2 wherein the security information element further comprises a field containing a length value that varies with a number of security combinations contained in the security information element.

5. The method of claim 4 wherein the length value is the number of octets allocated in the security information element for the information indicating the set of the one or more security combinations supported by the BSS.

6. The method of claim 3 wherein the security information element further comprises a field containing a value indicating a number of octets of the bitmap.

7. The method of claim 1 wherein the access point is an affiliated access point of an access point multi-link device.

8. The method of claim 1 wherein the one or more management frames are beacon frames.

9. The method of claim 1 wherein the one or more management frames are probe response frames.

10. A wireless access point (AP) comprising:
at least one memory element for storing data; and
at least one processor for executing instructions associated with the data, wherein executing the instructions causes the wireless station to perform operations, comprising:
implementing, by an access point, a Basic Service Set (BSS) for one or more wireless stations, the BSS identified by a Service Set Identifier (SSID);
accessing, by the access point, information indicating one or more security combinations supported by the BSS,
each of the one or more security combinations comprising an Authentication and Key (AKM) suite and a cipher suite;
encoding one or more management frames to include a security information element, the security information element including information indicating a set of the one or more security combinations supported by the BSS;
transmitting, by the access point, the one or more encoded management frames in the BSS.

11. The AP of claim 10 wherein the information indicating the set of the one or more security combinations supported by the BSS in the security information element comprises
a bitmap comprising a plurality of bits, each bit corresponding to a unique one of the one or more security profile values,
the value of each bit set to indicate whether the corresponding security profile value is supported by the BSS.

12. The AP of claim 11 wherein the security information element further comprises a field containing a value indicating a number of octets of the bitmap.

13. The AP of claim 10 wherein the access point is an affiliated access point of an access point multi-link device.

14. The AP of claim 10 wherein the one or more management frames are beacon frames.

15. The AP of claim 10 wherein the one or more management frames are probe response frames.

16. A non-transitory computer readable storage medium comprising instructions that when executed configure one or more processors of a wireless access point (AP) to perform operations comprising:
implementing, by an access point, a Basic Service Set (BSS) for one or more wireless stations, the BSS identified by a Service Set Identifier (SSID);
accessing, by the access point, information indicating one or more security combinations supported by the BSS,
each of the one or more security combinations comprising an Authentication and Key (AKM) suite and a cipher suite;
encoding one or more management frames to include a security information element, the security information element including information indicating a set of the one or more security combinations supported by the BSS;
transmitting, by the access point, the one or more encoded management frames in the BSS.

17. The non-transitory computer readable storage medium of claim 16 wherein the information indicating the set of the one or more security combinations supported by the BSS in the security information element comprises
a bitmap comprising a plurality of bits, each bit corresponding to a unique one of the one or more security profile values,
the value of each bit set to indicate whether the corresponding security profile value is supported by the BSS.

18. The non-transitory computer readable storage medium of claim 17 wherein the security information element further comprises a field containing a value indicating a number of octets of the bitmap.

19. The non-transitory computer readable storage medium of claim 16 wherein the access point is an affiliated access point of an access point multi-link device.

20. The non-transitory computer readable storage medium of claim 16 wherein the one or more management frames are beacon frames.

21. The non-transitory computer readable storage medium of claim 16 wherein the one or more management frames are probe response frames.
